(19) United States
(12) Patent Application Publication
(10) Pub. No.: US 2005/0031350 A1
(43) Pub. Date: Feb. 10, 2005

(54) Miniature optical free space transceivers

(76) Inventor: Ilan Haber, Bnei Brak (IL)

Correspondence Address: KATTEN MUCHIN ZAVIS ROSENMAN, 575 MADISON AVENUE, NEW YORK, NY, 10022-2585, US

(21) Appl. No.: 10/910,021

(22) Filed: Aug. 3, 2004

Related U.S. Application Data
(60) Provisional application No. 60/492,760, filed on Aug. 5, 2003.

(51) Int. Cl. H04B 10/00

(52) U.S. Cl. 398/128

(57) ABSTRACT

A free space optical transceiver including an electro-optical conversion unit having a transmission port and a reception port, with centers separated by a first distance; an optics unit adapted to lead a light beam from the atmosphere to the reception port and to lead a light beam from the transmission port to the atmosphere, wherein the optics unit includes at least one optical element having a diameter larger than the first distance.

### CROSS REFERENCE TO RELATED APPLICATIONS

This application claims the benefit from U.S. provisional application No. 60/492,760 filed on Aug. 5, 2003 by the same inventor.

### FIELD OF THE INVENTION

The present invention relates to free-space optical communications.

### BACKGROUND OF THE INVENTION

One method used for communicating data is transmission of modulated light beams. In many cases, the light beams are transmitted through optical fibers that provide a low attenuation medium for light beams, such that the light beams can be forwarded over large distances without being regenerated. When two-way transmission is required, two optical fibers are generally used. A terminal, including at least one pair of a transmitter and a receiver, is positioned at each end of the pair of fibers. Such terminals frequently handle many pairs of fibers. In order to keep the terminals as small as possible, the transmitters and receivers are packed as close as possible to each other. In an attempt to standardize the industry, predetermined distances between the transmitter and receiver of a single terminal, for a pair of parallel fibers, were set. Accordingly, transceivers such as the nine row transceivers, the Gigabit interface cards (GBIC) and the small form-factor pluggable (SFP) transceivers are available. U.S. patent publication 2003/0020986 to Pang et al., the disclosure of which is incorporated herein by reference, describes one such transceiver.

The cost of laying optical fibers in dense metropolitan areas is generally enormous if not prohibitive. Therefore, systems for transmission of data over modulated light beams in free space (e.g., the atmosphere), between a transmitter and a receiver, have been suggested.

Free space optical transceivers, however, need to overcome some technical problems. In order to transmit in both directions in parallel, the problem of cross talk between beams of the different directions needs to be addressed. One solution to the problem of cross talk is to have the transmitted and received beams use different frequencies. Another solution is to transmit in very short ranges and/or with high power levels that can overcome the cross talk. A third solution is to displace the transmitted and received beams relative to each other.

In addition, the light beam emitted from the transmitter is frequently scattered by dust or fog or is randomly refracted by turbulent air and/or random temperature fluctuations. Therefore, the receiver needs to have a lens of a large diameter, generally of at least 80-100 mm, which collects the light beam, or the receiver needs to include an array including a plurality of medium sized collecting lenses.

The cost and complexity of free space optic transceivers is therefore relatively high, and attempts have been made to reduce the cost.

U.S. Pat. No. 6,323,980 to Bloom, the disclosure of which is incorporated herein by reference, suggests defining pico-cells having a diameter of up to about 100 meters and locating a base station including laser transmitters, for example inch diameter laser transmitters, in each pico-cell. At such short ranges, the atmosphere conditions usually do not severely affect the transmission and relatively simple transceivers may be used.

PCT publication WO03/026165 to Choi et al., the disclosure of which is incorporated herein by reference, describes an integrated circuit carrying both an optical transmitter and an optical receiver. A predetermined distance separates the transmitter and receiver in order to avoid the transmitted and received beams from overlapping.

PCT publication WO02/058284 to Barbier et al., the disclosure of which is incorporated herein by reference, describes a compact free-space transceiver terminal for window mounting. This publication suggests using a small and lightweight terminal in order to simplify the mounting on the window. To this end, the '284 publication suggests folding the optical path between a collecting lens and the light detector. In addition, the publication suggests, in some embodiments, using a same telescope aperture for both the transmitted and received beams. A transmitter and receiver are positioned close to each other and their optical paths are combined using suitable optical elements.

Mounting a free space optical system on a window is also suggested in U.S. Pat. No. 6,609,690 to Davis and in PCT publication WO03/052972 to Bratt et al., the disclosures of which documents are incorporated herein by reference.

Several embodiments of the present invention are useful for instance in an elevator shaft where there is problem in the vertical riser for installing further communications cables between floors. Commonly, a line of sight exists between floors in the elevator shaft, however less than about 40 cm is available along side the elevator for equipment installation. Therefore, there is a need for miniature optical free space transceivers.

### SUMMARY OF THE INVENTION

A general aspect of some embodiments of the present invention relates to using an optical transceiver, including a transmitter and a receiver adjacent to each other, which was designed for use with a fiber optic pair, for free space transmission. The use of transceivers designed for a fiber, for free space transmission, allows use of standard small and cheap elements, which are widely available. This advantage has been found by the inventor of the present invention, to outweigh the costs of optically adapting the beams of the transceiver for free space transmission.

An aspect of some embodiments of the present invention relates to using, for free space optical data transmission of non-overlapping transmission and reception beams, a transceiver having transmission and reception ports distanced by less than the diameter of a lens or other optical element (e.g., a concave mirror) used for collecting a light beam directed to the receiver. In some embodiments of the invention, the distance between the transmission and reception ports is smaller than the radius of the collecting optical element of the receiver beam. Alternatively or additionally, the distance between the transmission and reception ports is smaller than the diameter of a lens or other optical element used to collimate the transmitted light beam. Optionally, the distance between the transmission and reception ports, is less than 10 millimeters, for example about 6.9 millimeters.

In some embodiments of the invention, optical elements, such as lenses and/or mirrors, positioned between the transmission and reception ports and the reception collecting lens, expand the effective distance between transmission and reception beams entering or exiting the ports, so that the beams do not overlap.

Alternatively, a collection lens that has a small transmission window with different optical properties from the rest of the collection lens, is used to allow the transmitted beam to be handled differently from the received beam.

Optionally, a beam emitter serving as the transmitter and a light detector serving as the receiver are directly behind the transmission and reception ports, such that the transmitter and receiver themselves are distanced by less than the diameter of the optical element used for collecting the light beam directed to the receiver. Alternatively or additionally, the transmitter and receiver are distanced from each other more than the transmission and reception ports. Optical elements are used to redirect the light beams from the relatively separated transmitter and receiver into their closely adjacent parallel positions in passing through the ports.

An aspect of some embodiments of the present invention relates to a transceiver (e.g., formed of an emitter and a detector) for free space transmission of parallel transmission and reception beams. The free-space transceiver includes an external port at which the beams are substantially parallel and distanced by a first distance and an internal port at which the beams are substantially parallel and distanced by a second distance smaller than the first distance. Optionally, the internal port comprises an emitter of the transmission beam and a detector of the reception beam. Alternatively, the distance between the emitter and the detector is larger than the distance between the beams at the internal port.

An aspect of some embodiments of the present invention relates to a free-space optical transceiver that includes a light detector having a casing adapted to receive optical fibers. The transceiver includes an optics unit for receiving a light beam from the atmosphere and directing the light towards the detector through an opening in the casing adapted to receive optical fibers. The opening adapted to receive optical fibers is not functional in the free-space transceiver (i.e., does not receive an optical fiber) and exists only due to the desirability of using a standard detector casing generally used for optical fibers, in free space transceivers.

There is therefore provided in accordance with an exemplary embodiment of the invention, a free space optical transceiver comprising an electro-optical conversion unit having a transmission port and a reception port, with centers separated by a first distance, an optics unit adapted to lead a light beam from the atmosphere to the reception port and to lead a light beam from the transmission port to the atmosphere, the optics unit includes at least one optical element having a diameter larger than the first distance.

Optionally, the transmission and reception ports are located on a same side of the conversion unit. Alternatively, the transmission and reception ports are located on different sides of the conversion unit. Optionally, the electro-optical conversion unit comprises an optical detector and an emitter separated by a distance not larger than the first distance.

Optionally, the electro-optical conversion unit comprises an optical detector and an emitter separated by a distance larger than the first distance. Optionally, the transmission and reception ports are separated by less than 10 millimeters. Optionally, the at least one optical element has a diameter larger than 60 millimeters. Optionally, the at least one optical element comprises a beam reception element. Optionally, the optics unit comprises a redirection apparatus adapted to direct a transmitted beam from the transmission port around the beam reception element. Optionally, the redirection apparatus comprises an optical fiber and/or one or more mirrors. Optionally, the beam reception element comprises a concave mirror and/or a collecting lens.

Optionally, the beam reception element comprises a portion having a different curvature from the rest of the element. Optionally, the portion of different curvature leads light from the transmission port to the atmosphere in parallel to light received from the atmosphere. Optionally, the beam reception element comprises an aperture. Optionally, the reception port is sized and shaped to receive an optical fiber. Optionally, the transmission port is sized and shaped to receive an optical fiber. Optionally, the electro-optical conversion unit comprises a detector formed of a photodiode that provides an electrical signal representing the light beam from the atmosphere to an amplifier, through a capacitor.

Optionally, the optics unit comprises an optical element cemented to the reception port of the electro-optical conversion unit. Optionally, the optics unit includes at least one optical element having a radius larger than the first distance.

There is further provided in accordance with an exemplary embodiment of the invention, a free space optical transceiver comprising an electro-optical conversion unit having a first transmission port and a first reception port, with centers separated by a first distance and an optics unit having a second transmission port and a second reception port, adapted to transfer a light beam from the atmosphere through the second reception port to the first reception port and to transfer a light beam from the first transmission port to the atmosphere through the second transmission port, wherein the second transmission and reception port are separated by a second distance larger than the first distance.

Optionally, the electro-optical conversion unit comprises an optical detector and a beam emitter separated by a distance not larger than the first distance. Alternatively, the electro-optical conversion unit comprises an optical detector and a beam emitter separated by a distance larger than the first distance.

### BRIEF DESCRIPTION OF THE DRAWINGS

Exemplary non-limiting embodiments of the invention will be described with reference to the following description of the embodiments, in conjunction with the figures. Identical structures, elements or parts which appear in more than one figure are preferably labeled with a same or similar number in all the figures in which they appear, and in which:

FIG. 1 is a schematic illustration of an optical free-space transmission system, in accordance with an exemplary embodiment of the present invention;

FIG. 2 is a schematic diagram of a transceiver, in accordance with an exemplary embodiment of the invention;

FIG. 3 is a schematic diagram of a transceiver, in accordance with another exemplary embodiment of the invention;

FIGS. 4-6 are schematic diagrams of transceivers, in accordance with still other exemplary embodiments of the invention;

FIG. 7 is a schematic diagram of an optics unit, in accordance with another exemplary embodiment of the invention;

FIG. 8 is a schematic diagram of a pair of transceivers including an alignment system, in accordance with an exemplary embodiment of the invention; and

FIG. 9 is a simplified block diagram of a front-end of a light detector, in accordance with an exemplary embodiment of the invention.

### DETAILED DESCRIPTION OF EXEMPLARY EMBODIMENTS

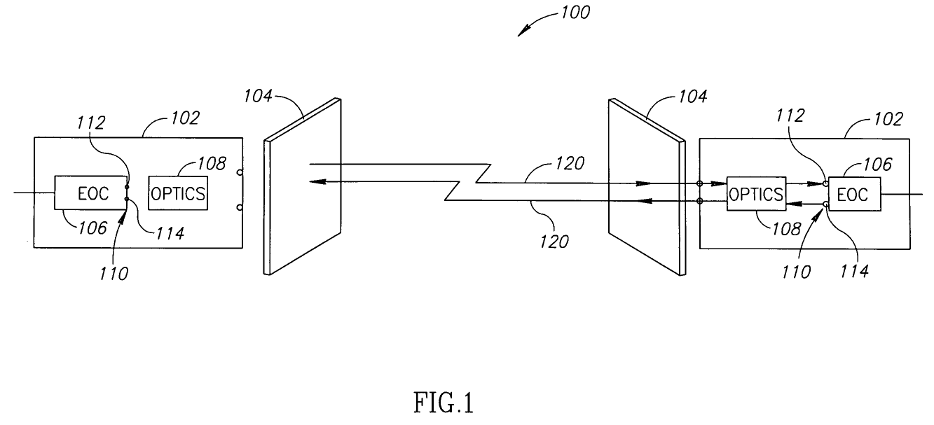

FIG. 1 is a schematic illustration of an optical free-space transmission system 100, in accordance with an exemplary embodiment of the present invention. System 100 comprises a pair of optical data transceivers 102, positioned in line of sight with each other. Transceivers 102 are optionally mounted on respective windows 104 in adjacent or otherwise neighboring buildings. Each of transceivers 102 transmits a modulated light beam 120, which carries data, to the other transceiver. Light beams 120 are substantially parallel so that the transceivers are easily aligned relative to each other for both transmission and reception. Transmitted and received light beams 120 may include light of the same wavelength or of different wavelengths. Each transceiver 102 optionally includes an electro-optical conversion unit (EOC) 106, adapted to generate a modulated light beam from a first electrical signal and to convert a modulated light beam into a second electrical signal, as described below.

Electro-optical conversion unit 106 has an interface 110 including a first aperture 112 (input port) through which it receives a light beam and a second aperture 114 (output port) through which it provides the generated light beam. Interface 110 is optionally of a size and shape designed for use with optical fibers, so that EOC 106 may be a standard element produced for use with optical fibers. In some embodiments of the invention, interface 110 includes sleeves adapted to receive optical fibers. It is noted that in accordance with some of these embodiments the sleeves are not used for inserting fibers and they are included in EOC 106 only because EOC 106 is a standard element produced primarily for use with fibers. Alternatively, interface 110 does not include sleeves for receiving optical fibers, for example when the production line for EOCs 106 is slightly varied for EOCs used for free space transmission. In an exemplary embodiment of the invention, the centers of apertures 112 and 114 are separated by a very small distance, e.g., 6.9 millimeters, allowing EOC 106 to be small and produced at low cost. In some embodiments of the invention, EOCs 106 comprise small form-factor pluggable (SFP) transceivers, gigabit interface converters (GBIC) and/or nine pin single row transceivers. An exemplary EOC 106 has a height of 11.8 millimeters, a 13.8 mm width and a 55.5 mm depth.

An optics unit 108 optionally receives the light beam generated by EOC 106 from second aperture 114 and collimates it into the transmitted modulated beam 120 in free space. Similarly, optics unit 108 optionally receives the light beam 120 transmitted from the opposite transceiver 102 and deflects it to first aperture 112. In order to properly receive the light beam 120 from the opposite transceiver 102, optics unit 108 includes a large collecting optical element (e.g., lens, mirror), which gathers the light of beam 120. The large collecting optical element has a diameter of at least the distance between apertures 112 and 114 and generally much larger than this distance. In an exemplary embodiment of the invention, the large collecting optical element has a diameter of at least 60 mm, for example between 80-100 mm, depending on the distance between the transceivers and the power of the transmitted beams 120.

Transceivers 102 may be mounted on windows 104 using substantially any method known in the art, such as direct bonding of a front pane of the transceiver 102 to the window pane using an adhesive, passive or active vacuum coupling and/or screws or other fasteners. Alternatively or additionally, transceivers 102 are mounted next to window 104 using a floor, wall and/or ceiling mounted fixture. Transceivers 102 are optionally of a small size, so that they take up only a minimal area of window 104, e.g., between 50-100 square centimeters. Alternatively or additionally, transceivers 102 are made relatively thin (e.g., 5-10 centimeters thick), such that they do not bulge out of drapes or curtains covering the window.

Although window mounting is very convenient in order to save space and protect against adverse weather conditions, transceivers 102 of the present invention may be mounted in any other location, such as on porches, railings, roof tops and/or on a mantle positioned outside a window. Furthermore, transceivers 102 need not be mounted on buildings and may be used to communicate between towers, houses, huts, tents, vehicles and/or any other entities requiring communication services. Transceivers 102 may be used also for vertical transmission, for example within buildings. For example, the transmission within buildings may be performed within an elevator peer, along stairs, along an outer wall of the building and/or in any other location where a free line of sight can be found between the transceivers.

Assuming a 2 mrad beam divergence, a transmission distance of 75 meters, an 80 millimeter collecting optical element, moderate fog conditions (e.g., 50 dB/Km) and a loss of about 12 dB due to windows of both transceivers 102, the total loss for a transmission between transceivers 102 is 21 dB. Such a loss is within the capabilities of available EOCs 106. It is noted that these calculations were brought by way of example and that system 100 may be used with longer transmission distances and/or worse atmospheric conditions by adjusting other loss factors (e.g., the window loss) and/or using EOCs 106 allowing higher loss rates.

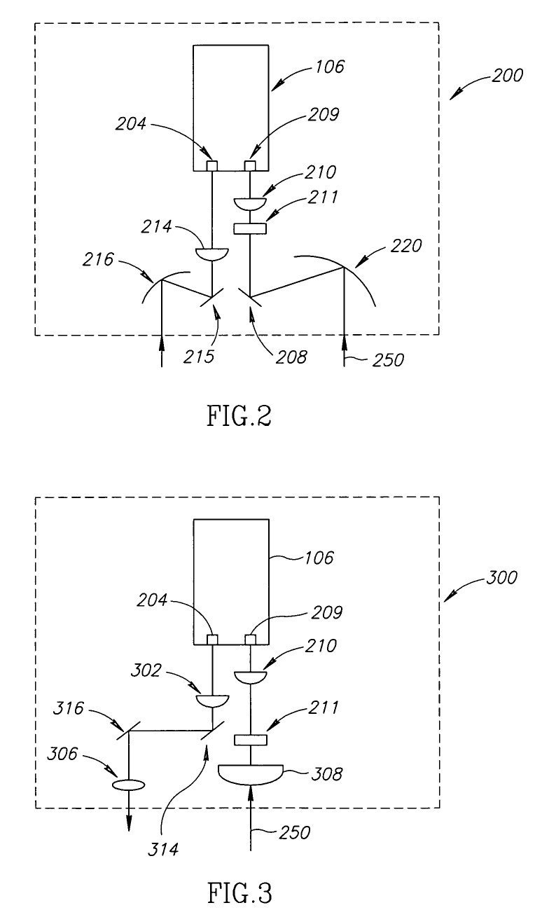

FIG. 2 is a schematic diagram of a transceiver 200, in accordance with an exemplary embodiment of the invention. Transceiver 200 comprises one possible implementation of transceiver 102, in which concave mirrors 216 and 220 are used, respectively, to collimate the transmitted and focus the received beams in optics unit 108 (FIG. 1). Reflecting mirrors 208 and 215 direct the light beams between the concave mirrors and EOC 106, so as to separate the received beam and the emitted beam from each other. EOC 106 comprises an emitter 204, such as a LED or laser diode (e.g., a vertical cavity surface emitting laser (VCSEL) or an edge emitting laser diode), and a signal detector 209, such as a PIN photodiode, a PIN/TIA integrated detector or an avalanche photodiode (APD). Transceiver 200 includes a concave mirror 220 which collects the light beam 250 from the remote transceiver 102 (FIG. 1) and directs the collected light beam toward a reflecting mirror 208, which in turn leads the light toward signal detector 209.

In some embodiments of the invention, for example in order to achieve an extended transmission range, additional optical elements such as a convergence lens 210 which increases the amount of light reaching detector 209 is positioned between mirror 208 and detector 209. Optionally, convergence lens 210 is distanced from detector 209 by a few millimeters, according to the focal length of lens 210. Alternatively, convergence lens 210 is located very close to detector 209, so as to increase the collection angle (numerical aperture) of the lens, and hence the amount of received light reaching detector 209. In some embodiments of the invention, convergence lens 210 is attached to detector 209 using an optical adhesive. In these embodiments, the light beam does not need to pass in a region having a different refractive index on its way from lens 210 to detector 209. Alternatively to a convergence lens 210, a non-imaging reflection surface is positioned very close to detector 209 in order to direct additional light to the photodiode. The reflection surface may be of any suitable shape, such as parabolical or conical.

Alternatively or additionally to convergence lens 210, a wavelength filter 211, which only allows passage of light in the wavelength band carrying data, is positioned between mirror 208 and detector 209. In some embodiments of the invention, wavelength filter 211 transfers remote optical wavelengths which are generally used for data, while substantially blocking wavelengths to which interfering background light generally belongs. Alternatively or additionally, filter 211 allows passage of the wavelengths of the received beam, while blocking wavelengths of the local transmitted beam, so as to reduce the interference from reflections of the transmitted beam. Although, lens 210 is shown closer to detector 209 than filter 211, when both lens 210 and filter 211 are included they may be positioned in any order.

The light beam generated by emitter 204 optionally passes through a collimating lens 214 and then impinges on a mirror 215 that deflects the light towards a concave mirror 216, which directs the emitted beam substantially in parallel to the received beam 250, towards the remote transceiver 102. Using the optical arrangement of transceiver 200, a sufficiently large concave mirror 220 is used while still enjoying the advantage of the small distance between emitter 204 and detector 209. In some embodiments of the invention, concave mirror 220 is larger than the distance between the centers of detector 209 and emitter 204.

The curvature of concave mirror 220 and the distance between concave mirror 220 and mirror 208 are optionally selected so that as much light as possible of the received beam impinge on detector 209. In an exemplary embodiment of the invention, mirror 220 is designed as a parabola having a focal length of about 35 mm and a diameter of 80-100 mm and mirror 216 is designed as a parabola having a focal length of 30 millimeters and a diameter of between about 10-20 millimeters (e.g., 15 millimeters). Reflecting mirrors 208 and 215 optionally have an extent of about 10 mm.

FIG. 3 is a schematic diagram of a transceiver 300, in accordance with another exemplary embodiment of the invention. Transceiver 300 is another possible implementation of transceiver 102, having an optics unit that uses a lens 308 to focus the light beam 250 received from the remote transceiver 102 (FIG. 1). Deflecting mirrors 314 and 316 are used to move the path of the transmitted beam beyond the area of lens 308, so that the light of the transmitted beam does not interfere with the reception by detector 209. Optionally, a lens 306, which may generally be smaller than lens 308, collimates the transmitted beam. Alternatively or additionally, a collimating lens 302, positioned before deflection mirror 314, is used. In accordance with this alternative, lens 306 may be eliminated or replaced by a flat window which prevents entrance of dust. As in transceiver 200, a condensing lens 210 and/or a wavelength filter 211, may be added to transceiver 300.

Alternatively to using mirrors 314 and 316 to redirect the transmitted beam, mirrors 314 and 316 may be used to redirect the received beam 250. This alternative may require a longer optical path due to the larger diameter of the received beam before it is focused. Further alternatively, redirection mirrors may be used for both the transmitted beam and the received beam, in order to achieve symmetry in the optics unit. This alternative, however, requires extra redirection mirrors not required if only one of the beams is redirected.

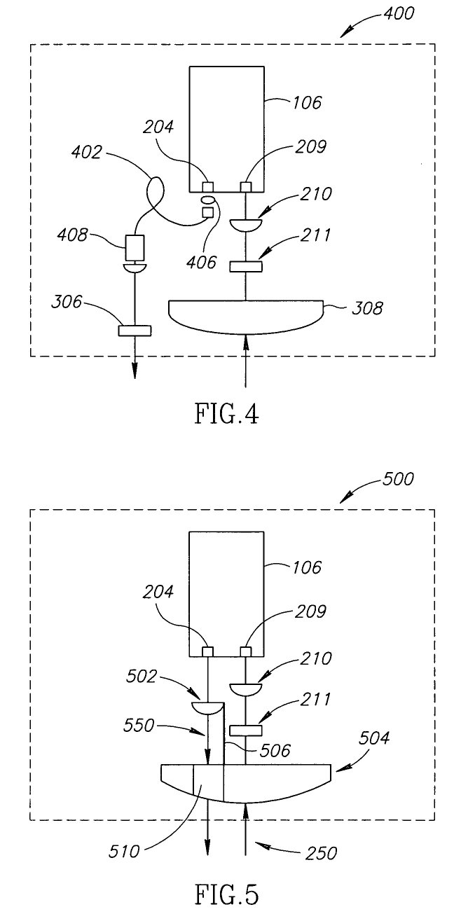

FIG. 4 is a schematic diagram of a transceiver 400, in accordance with another exemplary embodiment of the invention. Transceiver 400 is a variation of transceiver 300 of FIG. 3, in which an optical fiber 402 is used to distance the transmitted beam away from lens 308. Optionally, a coupling lens 406 is positioned between emitter 204 and optical fiber 402 to efficiently couple the emitted light from emitter 204 into optical fiber 402. Alternatively or additionally, a collimating lens 404 is positioned at the other end 408 of optical fiber 402, at a suitable point for collimating the emitted beam after it exits fiber 402.

Alternatively or additionally to using optical fiber 402 for the transmitted beam, an optical fiber is used to distance the received beam from the transmitted beam. This alternative is optionally used when accurate tracking and/or alignment mechanisms are used by transceivers 102, so that passing the received light beam 250 into the optical fiber does not incur large power losses.

FIG. 5 is a schematic diagram of a transceiver 500, in accordance with still another exemplary embodiment of the invention. In transceiver 500, the path of the transmitted beam 550 is not redirected in order to bypass a collecting lens 504 of the received beam 250, but rather is passed through an aperture 510 in lens 504. Transmitted beam 550 is collimated by a lens 502 and is then transmitted without redirection through aperture 510 toward the remote transceiver 102. Received beam 250 is collected by lens 504, except in the location of aperture 510, and is directed toward detector 209. Received light entering aperture 510 will reach emitter 204 and will be lost from reception. The size of aperture 510 is optionally of the size of transmitted beam 550, or slightly larger, so that the entire transmitted beam 550 is not affected by lens 504, while the power of the detected portion of the received beam is only slightly reduced due to aperture 510. Due to the small size of aperture 510 relative to the size of lens 504, the power reduction of the received light due to the portion passing through the aperture is minimal. An optional baffle 506 which absorbs light that misses aperture 510 may be used to substantially eliminate cross talk due to multiple scattering.

Alternatively to having an aperture 510, lens 504 may include a flat window which does not deflect light passing through it, but seals the optics unit of transceiver 500.

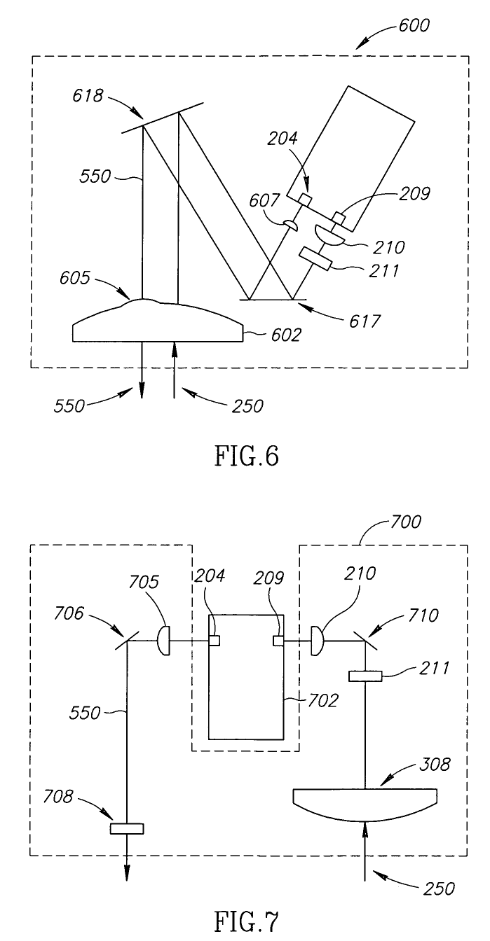

FIG. 6 is a schematic diagram of a transceiver 600, in accordance with still another exemplary embodiment of the invention. In transceiver 600, similar to transceiver 500, the emitted beam is not redirected in order to avoid a reception collecting lens 602. In transceiver 600, collecting lens 602 has different focal points for the transmitted beam and the received beam. Since the transmitted beam 550 is generated by beam emitter 204 close to lens 602, the beam 550 impinges only on a small area 605 of the lens. Optionally, a collimating lens 607 is additionally used in order that beam 550 will have a small diameter and will fit into small area 605. The received beam 250 from the remote transceiver, on the other hand, impinges on a large portion of lens 602. In area 605, lens 602 has a first curvature that collimates beams received from emitter 204 so that the axis of beam 550 is parallel to light beam 250 received from the remote transceiver. Received light beam 250 is collected by lens 602, except for area 605, toward detector 209. A small portion of the received light beam 250 impinges on area 605 of lens 602 and is lost, but this light portion is small.

In some embodiments of the invention, the optics unit of transceiver 600 includes mirrors 617 and 618 that fold the optical path between lens 602 and EOC 106. By folding the optical path, the thickness of the optics unit of transceiver 600 is decreased. In other embodiments, the optical path is not folded and a thicker optics unit is used.

FIG. 7 is a schematic diagram of an optics unit 700 adapted to operate with a respective OEC 702, in accordance with still another exemplary embodiment of the invention. In OEC 702, detector 209 and emitter 204 are located on opposite sides of the OEC rather than on the same side. The received beam 250 is collected by a reception lens 308 and is reflected from a reflecting surface 710 toward detector 209. An optional lens 210 and/or filter 211 may be placed along the path between lens 308 and detector 209, before or after reflecting surface 710. The emitted beam is optionally passed through a lens 705, which collimates the beam, and is then reflected from a reflection surface 706 to a window 708 for exit to the atmosphere in parallel to received beam 250. Alternatively, as described with reference to FIG. 3, collimating lens 705 may be positioned after reflection surface 706.

The relative simple arrangement of optics unit 700 is due to the different arrangement of detector 209 and emitter 204 within OEC 702 relative to the arrangement in EOC 106 that is standard in the finer optics industry. It is noted, however, that any of the above described optics arrangements may be used also with OEC 702.

Alternatively to using a collimating lens 705, the transmitted beam in this or other embodiments is passed through any other suitable optical element, such as through a diffractive element.

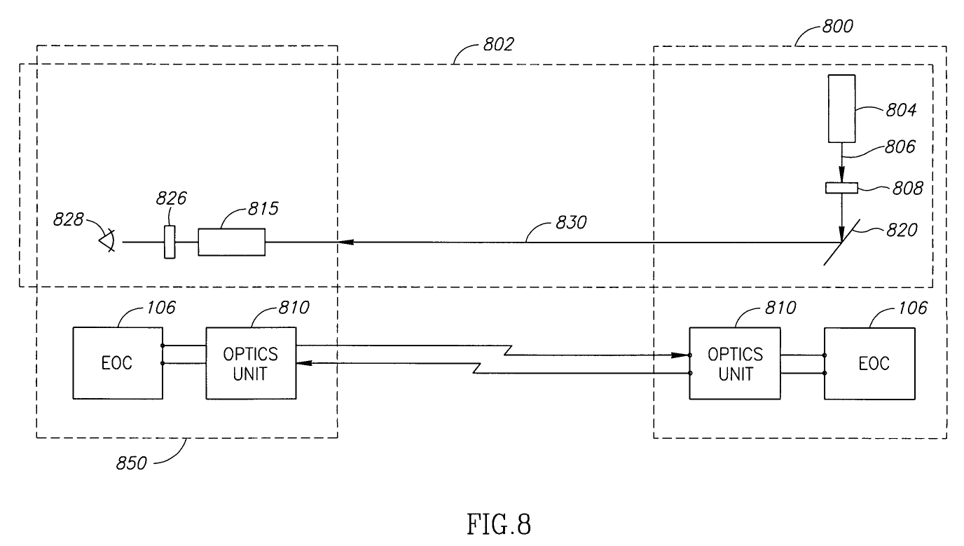

FIG. 8 is a schematic diagram of a set of transceivers 800 and 850 including an alignment system 802, in accordance with an exemplary embodiment of the invention. Each of transceivers 800 and 850 includes, in addition to an EOC 106 and an optics unit 810 (which may be in accordance with any of the above described embodiments), alignment apparatus, which together with the alignment apparatus of the other transceiver forms alignment system 802. Transceiver 800 optionally includes a light source 804 which emits a visible light beam 806. Visible light beam 806 is passed through an alignment target 808 (e.g., a cross hair target) which superimposes an image on the light beam. The light beam 830 with the superimposed image is reflected by an optional reflection surface 820 towards transceiver 850, in parallel to the light beams transmitted to and from optics unit 810 of transceiver 800. In transceiver 850, light beam 830 is collected by a telescope 815 toward a reticule 826. A viewer, represented by eye 828, adjusts the reception angle of transceiver 850, so that the superimposed images of target 808 and reticule 826 overlap, indicating that transceivers 800 and 850 are aligned.

The elements of alignment system 802 are factory aligned relative to the other elements of the transceivers to which they belong, such that optics units 810 of opposite transceivers are aligned, when target 808 and reticule 826 of alignment system 802 are aligned.

Alternatively to including only viewing apparatus of alignment system 802 in transceiver 850 and only transmission apparatus of the alignment system in transceiver 800, both transceivers include both transmission and viewing apparatus of the alignment system. In some embodiments of the invention, in accordance with this alternative, the viewing apparatus and the transmission apparatus of a transceiver, establish two different optical beam paths. In other embodiments of the invention, the same optical path is used for both the transmission and viewing apparatus. Optionally, in transceiver 800, reflection surface 820 is replaced by a splitter and a reticule positioned behind the splitter. In transceiver 850, a splitter and beam generation apparatus are optionally added. During installation, or otherwise when alignment is required, the more convenient transceiver for alignment, is used.

Alternatively to performing manual alignment, an automatic alignment system is used. A camera is positioned instead of eye 828 and the images acquired by the camera are analyzed to determine a required adjustment of transceiver 850. The adjustment is optionally repeated until the superimposed images of target 808 and reticule 826 are aligned. In this alternative, the light of light source 804 is not necessarily visible, but rather may be of any wavelength detectable by the camera. The automatic aligning may be performed at set-up, periodically and/or continuously, in which case alignment system 802 serves as a tracking system. It is noted that due to the small size and weight of transceivers 102, a pan and tilt apparatus and/or any other translation apparatus of the angle of transceiver 102 is relatively simple and can operate with relatively fast response times. Alternatively to performing the tracking and/or alignment by moving the entire transceiver, the alignment and/or tracking are performed by moving one of the reception optical elements (e.g., mirror 208, mirror 220, lens 210 or lens 308, FIGS. 2 and 3). Optionally, the tracking adjustment is performed by each of the transceivers 800 and 850 independently.

In some embodiments of the invention, instead of using an alignment system parallel to the modulated beams that carry the data, the light from light source 804 is combined into the path of one of the modulated data beams. Optionally, the light of light source 804 is in a bandwidth different from the modulated beam to which it is combined, so that the modulated beam is easily separated from the alignment light. Alternatively or additionally, light source 804 operates only for alignment and does not emit light during data transmission.

Alternatively to using actively generated light from light source 804 for alignment, light external to the alignment system, for example sun light or street lamp light, is used for the alignment. Target 806 is optionally placed at an external point of transceiver 800 where it reflects the external light towards telescope 815. Further alternatively, a small portion of the received modulated light beam is used for performing the alignment and/or tracking.

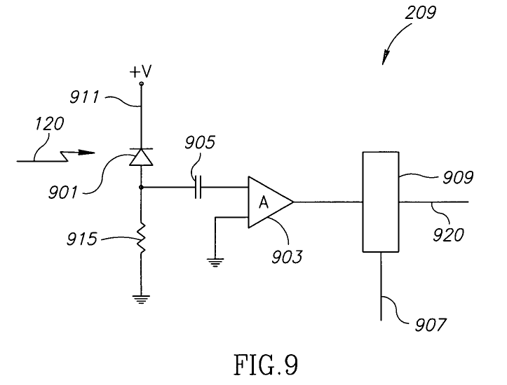

FIG. 9 is a simplified schematic diagram a front end 900 of the reception path of EOC 106 (FIG. 1), in accordance with an exemplary embodiment of the invention. In the embodiment of FIG. 9, EOC 106 comprises a photodiode 901 (generally corresponding to detector 209) to which the received beam is directed. Photodiode 901 is held between a bias voltage point 911 and a ground point 915, which set a working point of the photodiode. Photodiode 901 converts the light impinging on it into electrical signals which are passed to a preamplifier 903 (e.g., a trans-impedance amplifier). Optionally, a processor 909 is used to digitize the signals and/or bring the electrical signals to a required amplitude on a line 920. In some embodiments of the invention, processor 909 additionally provides an indication on the strength of the signal provided to the post amplifier, on a line 907. The signal strength indication is optionally used in aligning transceivers 102 relative to each other, by adjusting the orientations of the reception optics of the transceivers until the signal strength is maximized. Alternatively or additionally, the signal strength indication is used in monitoring the transmission quality of system 100.

In some embodiments of the invention, a capacitor 905 is positioned along the line leading from photodiode 901 to preamplifier 903. Capacitor 905 prevents DC and relatively low frequency signals from reaching preamplifier 903 and thus reduces the noise level of the amplified signals. The noise may be due, for example, to background light impinging on photodiode 901. The levels of background light are generally higher when EOC 106 is used for free space transmission. Alternatively or additionally, to using capacitor 905, other measures may be used to reduce the noise due to background light, such as surrounding transceiver 102 (FIG. 1) with oblique surfaces in directions other than of the received beam and/or performing digital filtering of the noise from the signal received from processor 909. It is noted that front ends of EOCs used with optical fibers may not include capacitor 905 as they generally do not suffer from high levels of background light. Therefore, the inclusion of capacitor 905 may require changing the production line of the EOCs.

In some embodiments of the invention, in order to support high data rates, photodiode 901 is made relatively large, for example having a dimension of between about 0.2-1 mm (with fibers a dimension of 0.14 mm is generally used). The exact size of the active area of the photodiode is optionally determined as a compromise between the desired data rate and/or transmission range and the cost of the photodiode. The working point of photodiode 901 is optionally set to a relatively high level, for example between about 50-60V, in order to lower the capacitance and decrease the response time of the photodiode, thus counteracting the larger size of the photodiode.

The larger photodiode and higher bias voltage level are optionally implemented by changing the production line of the EOCs. It is noted, that suitable transmission conditions can be achieved even without performing these changes such that off the shelf products can be used for the transmission. Further alternatively or additionally, the photodiode and/or the bias voltage level are changed after production, for example manually.

In some embodiments of the invention, a plurality of the optical elements of transceiver 102 are manufactured together as a single unit, for example using a casting of plastic resin in one mold, in order to reduce the manufacturing cost. Alternatively, each of the optical elements is produced separately, for simplicity.

It will be appreciated that the above-described methods and apparatus may be varied in many ways, including changing sizes and materials used in forming the transceivers. It should also be appreciated that the above described description of methods and apparatus are to be interpreted as including apparatus for carrying out the methods, and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

1. A free space optical transceiver comprising:
an electro-optical conversion unit having a transmission port and a reception port, with centers separated by a first distance;
an optics unit adapted to lead a light beam from the atmosphere to the reception port and to lead a light beam from the transmission port to the atmosphere,
wherein the optics unit includes at least one optical element having a diameter larger than the first distance.

2. The transceiver, according to claim 1, wherein the transmission and reception ports are located on a same side of the conversion unit.

3. The transceiver, according to claim 1, wherein the transmission and reception ports are located on different sides of the conversion unit.

4. The transceiver, according to claim 1, wherein the electro-optical conversion unit comprises an optical detector and an emitter separated by a distance not larger than the first distance.

5. The transceiver, according to claim 1, wherein the electro-optical conversion unit comprises an optical detector and an emitter separated by a distance larger than the first distance.

6. The transceiver, according to claim 1, wherein the transmission and reception ports are separated by less than 10 millimeters.

7. The transceiver, according to claim 1, wherein the at least one optical element has a diameter larger than 60 millimeters.

8. The transceiver, according to claim 1, wherein the at least one optical element comprises a beam reception element.

9. The transceiver, according to claim 8, wherein the optics unit comprises a redirection apparatus adapted to direct a transmitted beam from the transmission port around the beam reception element.

10. The transceiver, according to claim 9, wherein the redirection apparatus comprises an optical fiber.

11. The transceiver, according to claim 9, wherein the redirection apparatus comprises one or more mirrors.

12. The transceiver, according to claim 8, wherein the beam reception element comprises a concave mirror.

13. The transceiver, according to claim 8, wherein the beam reception element comprises a collecting lens.

14. The transceiver, according to claim 8, wherein the beam reception element comprises a portion having a different curvature from the rest of the element.

15. The transceiver, according to claim 14, wherein the portion of different curvature leads light from the transmission port to the atmosphere in parallel to light received from the atmosphere.

16. The transceiver, according to claim 8, wherein the beam reception element comprises an aperture.

17. The transceiver, according to claim 1, wherein the reception port is sized and shaped to receive an optical fiber.

18. The transceiver, according to claim 1, wherein the transmission port is sized and shaped to receive an optical fiber.

19. The transceiver, according to claim 1, wherein the electro-optical conversion unit comprises a detector formed of a photodiode which provides an electrical signal representing the light beam from the atmosphere to an amplifier, through a capacitor.

20. The transceiver according to claim 1, wherein the optics unit comprises an optical element cemented to the reception port of the electro-optical conversion unit.

21. The transceiver according to claim 1, wherein the optics unit includes at least one optical element having a radius larger than the first distance.

22. A free space optical transceiver comprising:
an electro-optical conversion unit having a first transmission port and a first reception port, with centers separated by a first distance; and
an optics unit having a second transmission port and a second reception port, adapted to transfer a light beam from the atmosphere through the second reception port to the first reception port and to transfer a light beam from the first transmission port to the atmosphere through the second transmission port,
wherein the second transmission and reception port are separated by a second distance larger than the first distance.

23. The transceiver, according to claim 22, wherein the electro-optical conversion unit comprises an optical detector and a beam emitter separated by a distance not larger than the first distance.

24. The transceiver, according to claim 22, wherein the electro-optical conversion unit comprises an optical detector and a beam emitter separated by a distance larger than the first distance.
